(19) United States
(12) Patent Application Publication
(10) Pub. No.: US 2009/0012860 A1
(43) Pub. Date: Jan. 8, 2009

(54) REMUNERATION OF MEDICAL DONORS

(76) Inventor: Gunnar R. Wieboldt, Cary, NC (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 12/132,389

(22) Filed: Jun. 3, 2008

Related U.S. Application Data
(60) Provisional application No. 60/941,784, filed on Jun. 4, 2007.

(51) Int. Cl. G06Q 30/00; G06Q 50/00

(52) U.S. Cl. 705/14

(57) ABSTRACT

A method for incentivizing donations by plasma donors is provided.

### RELATED APPLICATIONS

The present application claims the benefit of U.S. Application No. 60/941,784 filed Jun. 4, 2007, which is incorporated herein by reference in their entirety.

### FIELD OF THE INVENTION

The medical donor industry, and the plasma industry in particular, is plagued by poor image associated with remunerated donors. Because donating plasma is seen as a desperate measure taken by poor people, people who might otherwise donate out of charitable impulses do not. As a consequence the donor pool is restricted unnecessarily and those that do donate often run a higher statistical pathogen safety risk.

### BACKGROUND OF THE INVENTION

In general a plasma donation program in which donors felt that they were helping patients (as with the American Red Cross) AND that they are providing a monetary assistance to a charitable cause (not included with the Red Cross), could improve the rate and breadth of donations. To accomplish this, in one embodiment of the present invention, a donor would be given a list of different methods of remuneration from cash to a gap insurance program with the later options encouraged.

### SUMMARY OF THE INVENTION

One embodiment of the present invention provides a link between “paid donation” and plasma. The target population is not motivated by receiving a few dollars, but is motivated by the feeling that they helped someone. Consequently, one embodiment includes a tiered compensation scheme that disfavors cash and promotes charitable giving as follows (the actual dollar amounts are estimates, what is important is the relative value):

In one embodiment, a plasma donor can elect to:
a. Receive a $30.00 check
b. Receive $40.00 gift certificate from participating vendors (e.g., record stores for college towns, school supply stores for suburbs)
c. Donate $50.00 to the product replacement program for a NAMED INDIVIDUAL who may experience an insurance gap or cannot afford co-pays (more on this following)
d. A $60.00 donation made either anonymously or in their name to any local, regional, national, or international charity on our participating roster.
e. A $70.00 donation to a product replacement program for COMMON POOL who may experience an insurance gap or cannot afford co-pay amounts.

### BRIEF DESCRIPTION OF THE DRAWINGS

FIG. 1 is a general purpose processor and memory device that can implement one embodiment of the present invention in which the functionality is stored as instructions on the memory device that are executed by the processor.

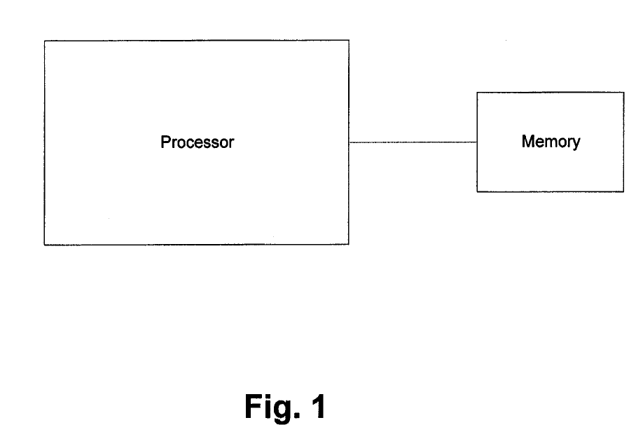

FIG. 2 is a flow diagram of the functionality of one embodiment of the present invention.

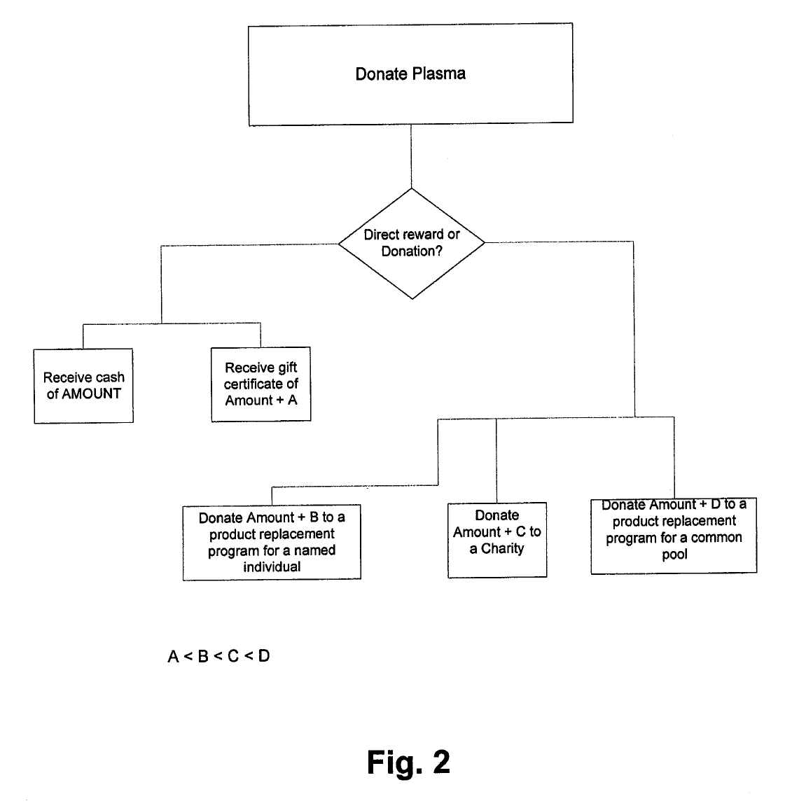

### DETAILED DESCRIPTION

Product Replacement Program: Because many of the patients who use plasma products will be on such products for extended periods (or life), the likelihood that they will at some point exhaust their insurance is high. One embodiment uses this to motivate that patient's friends and family to donate plasma on his behalf. He will accrue credits (in the form of replacement product) to cover for this eventuality.

There may also be the opportunity to segregate plasma donations whose donors elected options (d) or (e) above for markets such as Japan. For item “d” charity outreach representatives can try and find the hot button local charity for a target group (e.g., the homeless shelter sponsored by Church XYZ) and put that charity on the plasma center most convenient for them. In other words the pastor can tell his congregation to make donations as each donations will result in a $75.00 check going to the shelter (of which a good portion is presumably tax deductible for the organizing company and the annual results of such giving, either by the organizing company or industry as a whole, can be published to further improve the appeal of donating).

A key aspect to reducing administrative complexity and improving the probability that there will be a tax deduction for remuneration, is that owner of the plasma center be the one that makes the donation (either in the name of the donor or anonymously as the donor may elect) and receives the credit.

Furthermore, the patient advocacy groups could be utilized to help drum up donor support for individual patients in their home community and possibly have these organizations help find volunteers who could donate their salary equivalent to such causes in exchange for assisting in the collection process.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method of incentivizing plasma donors, the method comprising providing a plasma donor with a choice of the following for each donation:
a) a check for n dollars;
b) a gift certificate for m dollars from participating vendors;
c) a donation of o dollars made either anonymously or in the donors name to a product replacement program for a named individual who may experience an insurance gap or cannot afford co-pays;
d) a donation of p dollars made either anonymously or in the donors name to a participating charity; or
e) a donation of q dollars to a product replacement program for a common pool who may experience an insurance gap or cannot afford co-pay amounts,
wherein n<m<o<p<q.

2. The method of claim 1, wherein n is from about $20 to about $40 dollars in 2008 US currency.

3. The method of claim 1, wherein n is about $30 dollars based in 2008 US currency.

4. The method of claim 1, wherein donations from donors choosing either d) or e) are segregated for specific use.

5. The method of claim 4, wherein the specific use is in preparing products for distribution to a specific market.

6. The method of claim 5, wherein the specific market is Japan.
